(19) United States
(12) Patent Application Publication
(10) Pub. No.: US 2014/0130129 A1
(43) Pub. Date: May 8, 2014

(54) COUNT VALUES TO DETECT DISCONNECTED CIRCUIT

(71) Applicant: Curtis Timothy Gross, Rocklin, CA (US)

(72) Inventor: Curtis Timothy Gross, Rocklin, CA (US)

(73) Assignee: HEWLETT-PACKARD DEVELOPMENT COMPANY, L.P., Houston, TX (US)

(21) Appl. No.: 14/127,595

(22) PCT Filed: Aug. 9, 2011
(86) PCT No.: PCT/US2011/047071

§ 371 Date: Dec. 19, 2013

(51) Int. Cl. H04L 29/06

(52) U.S. Cl. CPC H04L 63/08
USPC 726/3

(57) ABSTRACT

A connector including a circuit configured to be coupled to a network and an end device. The circuit configured to transmit count values in a count sequence over the network to detect whether the circuit has been, at least temporarily, disconnected from at least one of the network and the end device.

### BACKGROUND

In the field of networking, network security includes the provisions and policies adopted by a network administrator to prevent and monitor unauthorized access, misuse, modification, and denial of the computer network and network-accessible resources. Network security is the authorization of access to data in a network, which is controlled by the network administrator. Typically, users are assigned an identification and password that allows them access to information and programs within their authority. Network security covers a variety of computer networks, both public and private, that are used in everyday jobs conducting transactions and communications among businesses, government agencies, and individuals. Networks can be private, such as within a company, or open to public access.

In most office environments, a majority of the network traffic that is used to communicate within the office environment is not encrypted. In addition, the network and network devices are usually only minimally physically secured within the office environment. Often, in these environments, users still expect network traffic to be private, such as when printing a confidential document to a shared printer and quickly walking to the printer to pick up the document. However, the document could be intercepted electronically. Network switches and routers ensure that network traffic is routed to the intended end device(s), but some electronic devices are transparent to both ends and can be inserted between the network switch and end device to eavesdrop on unencrypted network traffic.

In high security environments, such as banking and national security, network security is critical. Often, in these environments, substantially all network traffic is encrypted and physical security measures are taken to ensure that the network and network devices are not tampered with and that no one has unauthorized access to data in the network. Sometimes, armored casing is used to prevent tampering with the network and network devices. This may be acceptable in high security environments, but in lower security environments, such as most office environments, it is not practical to encrypt all network traffic and enclose the network and network devices in armored casing.

### BRIEF DESCRIPTION OF THE DRAWINGS

FIG. 1 is a diagram illustrating one embodiment of a network system that includes network security.

FIG. 2 is a diagram illustrating one embodiment of a connector disconnected from an end device.

FIG. 3 is a diagram illustrating one embodiment of a connector disconnected form a network.

FIG. 4 is a diagram illustrating one embodiment of a mobile device communicatively coupled to a network device.

FIG. 5 is a flow chart illustrating one embodiment of network communications using the system of FIG. 1.

FIG. 6 is a flow chart illustrating one embodiment of initializing or resetting a network device using a mobile device.

FIG. 7 is a flow chart illustrating one embodiment of resetting a connector and opening communications between a network device and an end device.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various exemplary embodiments described herein may be combined with each other, unless specifically noted otherwise.

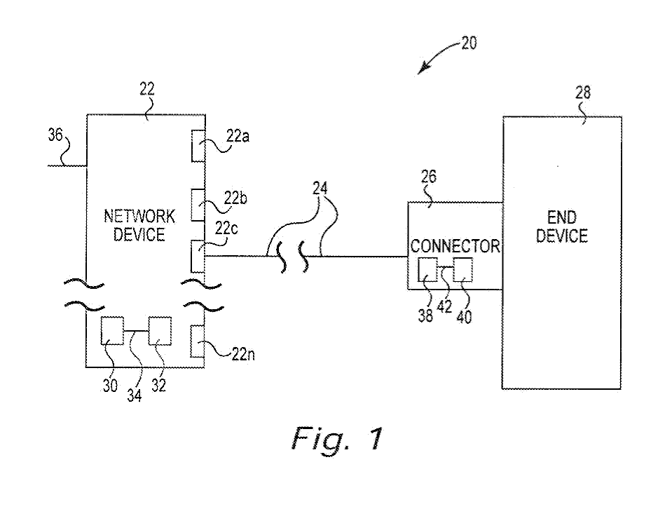

FIG. 1 is a diagram illustrating one embodiment of a network system 20 that includes network security. System 20 includes a network device 22, a network 24, a connector 26, and an end device 28. In one embodiment, system 20 is in an office environment. In one embodiment, system 20 is in a lower security environment.

System 20 provides network security by detecting whether connector 26 has been, at least temporarily, disconnected from network 24 or end device 28, after secure network communications have been established between network device 22 and end device 28. System 20 also detects whether network device 22 has been, at least temporarily, disconnected from end device 28. If connector 26 has not been disconnected from network 24 or end device 28, network device 22 continues communicating with end device 28. If connector 26 has been, at least temporarily, disconnected from network 24 or end device 28, network device 22 discontinues communications with end device 28. After discontinuing communications with end device 28, network device 22 can still communicate with connector 26 or other devices, such as a mobile initialization device. However, network device 22 does not transmit network traffic to end device 28 until network device 22 and connector 26 have been reinitialized or reset and secure communications have been established between network device 22 and end device 28. By detecting that connector 26 has been disconnected from network 24 or end device 28 and by discontinuing communications between network device 22 and end device 28, system 20 prevents electronic devices from being inserted into network 24 and eavesdropping on network traffic.

Network device 22 includes ports 22a-22n, a computing device 30, and memory 32. Network device 22 is communicatively coupled to network 24 via port 22c and computing device 30 is electrically coupled to memory 32 via data path 34. Network device 22 receives control signals via control signal path 36 and transmits and receives network traffic via ports 22a-22n. Network device 22, including ports 22a-22n, can be directly controlled via control signals on control path 36. Computing device 30 controls network device 22. In one embodiment, computing device 30 is a controller. In one embodiment, computing device 30 is a microprocessor. In one embodiment, memory 32 includes volatile and non-volatile memory. In one embodiment, memory 32 includes random access memory. In one embodiment, memory 32 includes read only memory. In one embodiment, network device 22 is a switch. In one embodiment, network device 22 is a router.

Connector 26 includes a connector computing device 38 and memory 40. Connector 26 is communicatively coupled to network 24 and to end device 28, and connector computing device 38 is electrically coupled to memory 40 via data path 42. Connector 26 receives and transmits signals over network 24, and connector 26 passes network traffic between network 24 and end device 28. Connector computing device 38 controls connector 26. In one embodiment, connector computing device 38 is a controller. In one embodiment, connector computing device 38 is a microprocessor. In one embodiment, memory 40 includes volatile and non-volatile memory. In one embodiment, memory 40 includes random access memory. In one embodiment, memory 40 includes read only memory. In one embodiment, memory 40 includes FLASH memory. In one embodiment, connector 26 includes an RJ45 connector. In one embodiment, connector 26, including connector computing device 38, operates as a layer 2 device on an Ethernet network. In one embodiment, connector 26 is built into and part of end device 28. In one embodiment, connector 26 is an external, separate component coupled to end device 28. In other embodiments, system 20 includes multiple connectors and multiple end devices communicatively coupled to network device 22 through ports 22a-22n.

System 20 passes network traffic between network device 22 and end device 28. In one direction, network traffic is transmitted from network device 22 and port 22c onto network 24. The network traffic is received by connector 26 and passed through connector 26 to end device 28. In the other direction, network traffic is transmitted by end device 28 through connector 26 to network 24. This network traffic is received at port 22c and network device 22. In one embodiment, network 24 is an Ethernet network.

To provide network security, a secure network connection between network device 22 and end device 28 is established by the network administrator or network personnel. After this secure network connection has been made, connector 26 transmits count values in a count sequence over network 24. Network device 22 receives the count values over network 24 and analyzes the received count values. Network device 22 determines from the count values whether connector 26 has been, at least temporarily, disconnected from network 24 or end device 28. If connector 26 has been disconnected from network 24 or end device 28, network device 22 discontinues transmitting network traffic to end device 28. If connector 26 has not been disconnected from network 24 or end device 28, network device 22 continues transmitting network traffic to end device 28.

One of two initialization procedures is used to establish a secure network connection between network device 22 and end device 28. In one initialization procedure, the network administrator or network personnel verify that network device 22 is communicatively coupled to network 24 via port 22c and that connector 26 is communicatively coupled to network 24 and end device 28, with no devices that could be used for eavesdropping between network device 22 and end device 28. Next, network device 22 is controlled manually or via control signals on control path 36 to establish communications with connector 26. In another initialization procedure, the network administrator or network personnel verify that network device 22 is communicatively coupled to network 24 via port 22c. Next, the network administrator or network personnel go to the location of the end device 28 and use a mobile device to communicate with network device 22 through port 22c over network 24. Where, the mobile device is used to direct network device 22 to establish communications with connector 26. Next, the network administrator or network personnel communicatively couple connector 26 to network 24 and to end device 28, with no devices that could be used for eavesdropping between network device 22 and end device 28.

After network device 22 has been initialized or reset, network device 22 transmits a reset signal or reset packet(s) to connector 26. The reset signal includes data for subsequent count value transmissions from connector 26 to network device 22. In one embodiment, the reset signal includes an initial count value for the count sequence. In one embodiment, the reset signal indicates whether to increment or decrement the count value between count value transmissions. In one embodiment, the reset signal includes an increment or decrement value to be used to change the count value between transmitted count values. In one embodiment, the reset signal includes a time interval to be used between count value transmissions, where the time interval between count value transmissions can be made longer or shorter to accommodate bandwidth considerations and the time interval can be made shorter to reduce the window of opportunity for eavesdropping on network 24. In one embodiment, the reset signal includes a session identification number that can be transmitted with each count value. In one embodiment, the reset signal includes an encryption key, where connector 26 encrypts the count value with the encryption key. In one embodiment, network device 22 provides different encryption keys for different ports 22a-22n or different groups of ports 22a-22n.

Connector 26 receives the reset signal from network device 22 and begins transmitting count values in a count sequence to network device 22. In one embodiment, connector 26 begins with the initial count value received in the reset signal. In one embodiment, connector 26 increments or decrements the count value between count value transmissions based on the increment or decrement indication in the reset signal. In one embodiment, connector 26 increments or decrements the count value by the increment or decrement value received in the reset signal. In one embodiment, connector 26 transmits the count values at the time interval received in the reset signal between transmitted count values. In one embodiment, connector 26 transmits the session identification number received in the reset signal with the count value. In one embodiment, connector 26 encrypts each count value with the encryption key received in the reset signal.

After network device 22 begins receiving the count values, network device begins communicating network traffic to end device 28. Connector 26 continues transmitting count values and network device 22 continues receiving and analyzing the count values to detect and determine whether connector 26 has been, at least temporarily, disconnected from network 24 or end device 28.

If connector 26 is, at least temporarily, disconnected from network 24 or end device 28, connector 26 discontinues the count sequence of the count values. In one embodiment, connector 26 resets the count value to a reset value, such as zero, and transmits the reset value. In one embodiment, connector 26 resets the count value to a network reset value if connector 26 has been disconnected from network 24 and to a device reset value if connector 26 has been disconnected from end device 28, where the network reset value is different from the device reset value. In one embodiment, connector 26 is powered over network 24 and connector 26 discontinues the count sequence with the count values if connector 26 is powered down, such as by at least temporarily disconnecting connector 26 from network 24. In one embodiment, network 24 is an Ethernet network and connector 26 receives its power over Ethernet (PoE) and connector 26 discontinues the count sequence of count values if connector 26 is powered down, such as by at least temporarily disconnecting connector 26 from network 24.

Network device 22 receives the count value transmitted from connector 26 and analyzes the count value to determine whether the count value continues the count sequence. If the count value continues the count sequence, network device 22 continues communicating with end device 28. If the count value discontinues the count sequence, network device 22 discontinues communicating with end device 28. In one embodiment, network device 22 determines whether the count value was transmitted in a count value sequence beginning with the initial count value provided in the reset signal. In one embodiment, network device 22 determines whether the count value was incremented or decremented according to the increment or decrement indication and value provided in the reset signal. In one embodiment, network device 22 determines whether the count value was transmitted at the time interval provided in the reset signal. In one embodiment, network device 22 determines whether the session identification number provided in the reset signal accompanies the count value. In one embodiment, network device 22 decrypts an encrypted count value to obtain a decrypted count value that is used to determine whether the count value continues the count sequence.

If the count value discontinues the count sequence and network device 22 discontinues communicating with end device 28, network device 22 and connector 26 are reset to re-establish communications between network device 22 and end device 28.

One of two reset procedures is used to re-establish a secure network connection between network device 22 and end device 28. In one reset procedure, the network administrator or network personnel verify that network device 22 is communicatively coupled to network 24 via port 22c and that connector 26 is communicatively coupled to network 24 and end device 28, with no devices that could be used for eavesdropping between network device 22 and end device 28. Next, network device 22 is controlled manually or via control signals on control path 36 to establish communications with connector 26. In another reset procedure, the network administrator or network personnel verify that network device 22 is communicatively coupled to network 24 via port 22c. Next, the network administrator or network personnel go to the location of the end device 28 and use a mobile device to communicate with network device 22 through port 22c over network 24, where the mobile device is used to direct network device 22 to establish communications with connector 26. Next, the network administrator or network personnel communicatively couple connector 26 to network 24 and to end device 28, with no devices that could be used for eavesdropping between network device 22 and end device 28.

After network device 22 has been reset, network device 22 transmits another reset signal to connector 26. In one embodiment, the reset signal includes an initial count value for the count sequence. In one embodiment, the reset signal indicates whether to increment or decrement the count value between count value transmissions. In one embodiment, the reset signal includes an increment or decrement value to be used to change the count value between transmitted count values. In one embodiment, the reset signal includes a time interval to be used between count value transmissions, where the time interval between count value transmissions can be made longer or shorter to accommodate bandwidth considerations and the time interval can be made shorter to reduce the window of opportunity for eavesdropping on network 24. In one embodiment, the reset signal includes a session identification number that can be transmitted with each count value. In one embodiment, the reset signal includes an encryption key, where connector 26 encrypts the count value with the encryption key. In one embodiment, network device 22 provides different encryption keys for different ports 22a-22n or different groups of ports 22a-22n.

Connector 26 receives the reset signal and begins transmitting count values in a count sequence over network 24. Network device 22 receives the count values and begins communicating network traffic to end device 28. Connector 26 continues transmitting count values and network device 22 continues receiving and analyzing the count values to detect and determine whether connector 26 has been, at least temporarily, disconnected from network 24 or end device 28. The process continues as described herein.

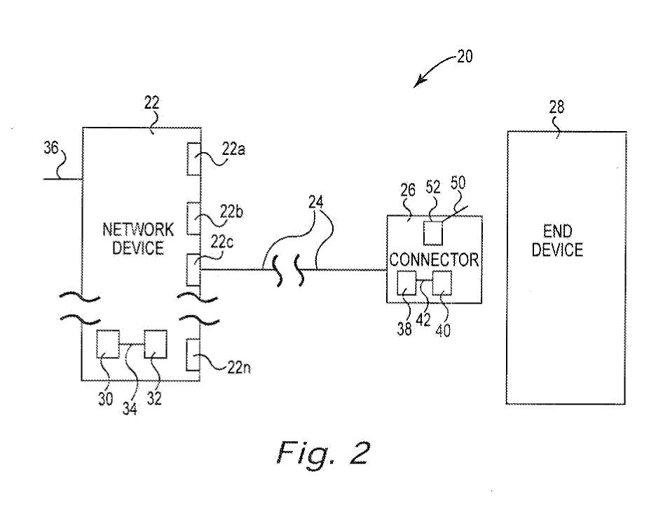

FIG. 2 is a diagram illustrating one embodiment of connector 26 disconnected from end device 28. Connector 26 includes a connection tab 50 that is depressed to disconnect connector 26 from end device 28. Connection tab 50 is connected to an electronic switch 52, such that depressing connection tab 50 activates switch 52 to transmit a signal to connector computing device 38. Connector computing device 38 receives this signal and resets the count value to a reset count value, such as zero. In one embodiment, connector 26 resets the count value to a device reset value that indicates connector 26 has been disconnected, at least temporarily, from end device 28. In other embodiments, connector 26 includes circuitry that electronically detects that connector 26 has been disconnected from end device 28, such as by the absence of a voltage and/or active signals on one or more conductors of connector 26.

Assuming secure network communications were established between network device 22 and end device 28, and connector 26 was sending count values in a count sequence to network device 28, depressing connection tab 50 resets the count value to a reset count value and discontinues the count sequence of the count values. Connector 26 transmits this reset count value over network 24. Network device 22 receives the reset count value transmitted from connector 26 and analyzes the count value to determine whether the count value continues the count sequence. Since the count value discontinues the count sequence, network device 22 discontinues communications with end device 28.

As described above, one of two reset procedures can be used to re-establish a secure network connection between network device 22 and end device 28. In one reset procedure, the network administrator or network personnel verify that network device 22 is communicatively coupled to network 24 via port 22c and that connector 26 is communicatively coupled to network 24 and end device 28, with no devices that could be used for eavesdropping between network device 22 and end device 28. Next, network device 22 is controlled manually or via control signals on control path 36 to establish communications with connector 26. In another reset procedure, the network administrator or network personnel verify that network device 22 is communicatively coupled to network 24 via port 22c. Next, the network administrator or network personnel go to the location of the end device 28 and use a mobile device to communicate with network device 22 through port 22c over network 24, where the mobile device is used to direct network device 22 to establish communications with connector 26. Next, the network administrator or network personnel communicatively couple connector 26 to network 24 and to end device 28, with no devices that could be used for eavesdropping between network device 22 and end device 28.

After network device 22 has been reset, network device 22 transmits a reset signal over network 24. Connector 26 receives the reset signal and begins transmitting count values in a count sequence over network 24. Network device 22 receives the count values and begins communicating network traffic to end device 28. Connector 26 continues transmitting count values and network device 22 continues receiving and analyzing the count values to detect and determine whether connector 26 has been, at least temporarily, disconnected from network 24 or end device 28.

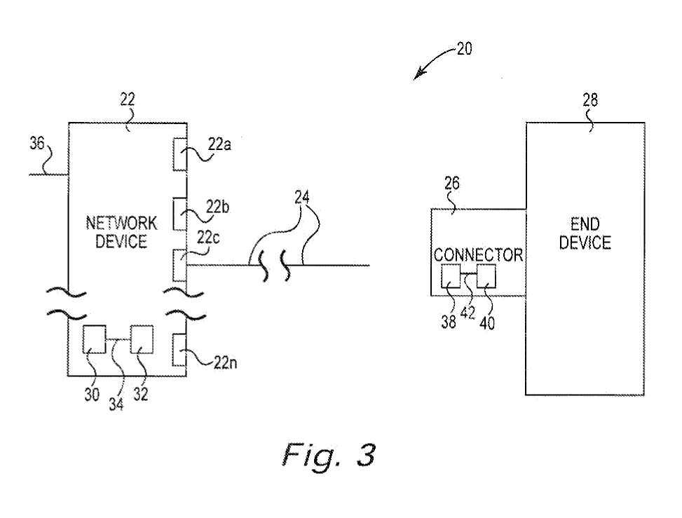

FIG. 3 is a diagram illustrating one embodiment of connector 26 disconnected from network 24. Connector 26 is powered over network 24. Disconnecting connector 26 from network 24 or cutting network 24, disrupts power to connector 26 and powers down connector 26. If connector 26 is powered down, connector 26 resets the count value to a reset count value, such as zero. In one embodiment, connector 26 resets the count value to a network reset value that indicates connector 26 has been disconnected, at least temporarily, from network 24. In one embodiment, network 24 is an Ethernet network and connector 26 receives its PoE. In other embodiments, connector 26 includes circuitry that electronically detects that connector 26 has been disconnected from network 24, such as by the absence of a voltage and/or active signals on one or more conductors of connector 26.

Assuming secure network communications were established between network device 22 and end device 28, and connector 26 was sending count values in a count sequence to network device 28, disconnecting connector 26 from network 24 powers down connector 26 and resets the count value to a reset count value that discontinues the count sequence of the count values. If connector 26 is reconnected to network 24, connector 26 transmits this reset count value over network 24. Network device 22 receives the reset count value transmitted from connector 26 and analyzes the count value to determine whether the count value continues the count sequence. Since the count value discontinues the count sequence, network device 22 discontinues communications with end device 28. If connector 26 is not reconnected to network 24, network device 22 detects the absence of a count value transmission from connector 26 at the designated time interval and discontinues communications with end device 28.

As described above, one of two reset procedures can be used to re-establish a secure network connection between network device 22 and end device 28. In one reset procedure, the network administrator or network personnel verify that network device 22 is communicatively coupled to network 24 via port 22c and that connector 26 is communicatively coupled to network 24 and end device 28, with no devices that could be used for eavesdropping between network device 22 and end device 28. Next, network device 22 is controlled manually or via control signals on control path 36 to establish communications with connector 26. In another reset procedure, the network administrator or network personnel verify that network device 22 is communicatively coupled to network 24 via port 22c. Next, the network administrator or network personnel go to the location of the end device 28 and use a mobile device to communicate with network device 22 through port 22c over network 24, where the mobile device is used to direct network device 22 to establish communications with connector 26. Next, the network administrator or network personnel communicatively couple connector 26 to network 24 and to end device 28, with no devices that could be used for eavesdropping between network device 22 and end device 28.

After network device 22 has been reset, network device 22 transmits a reset signal over network 24. Connector 26 receives the reset signal and begins transmitting count values in a count sequence over network 24. Network device 22 receives the count values and begins communicating network traffic to end device 28. Connector 26 continues transmitting count values and network device 22 continues receiving and analyzing the count values to detect and determine whether connector 26 has been, at least temporarily, disconnected from network 24 or end device 28.

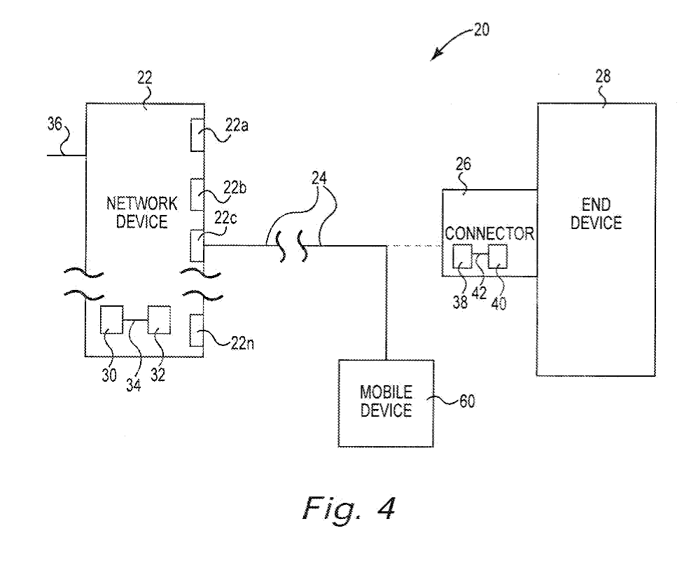

FIG. 4 is a diagram illustrating one embodiment of a mobile device 60 communicatively coupled to network device 22 at port 22c. Mobile device 60 is used to initialize or reset network device 22 at port 22c. In one embodiment, mobile device 60 is a small, handheld computing device. In one embodiment, mobile device 60 includes an RJ45 Ethernet connection. In other embodiments, mobile device 60 is communicatively coupled to network device 22 at another suitable port to reset network device 22 and port 22c.

To begin initial communications between network device 22 and end device 28 or to re-establish communications between network device 22 and end device 28, such as after connector 26 discontinues the count sequence and network device 22 discontinues communicating with end device 28, the network administrator or network personnel first initialize or reset network device 22 and connector 26.

In one initialization or reset procedure, the network administrator or network personnel verify that network device 22 is communicatively coupled to network 24 via port 22c, with no devices that could be used for eavesdropping between network device 22 and network 24. Next, the network administrator or network personnel go to the location of the end device 28 and communicatively couple mobile device 60 to network device 22 at port 22c over network 24.

Mobile device 60 is pre-loaded with a private encryption key that is shared with network device 22. After mobile device 60 is connected to network device 22 via network 24, mobile device 60 and network device 22 communicate to initialize or reset network device 22. In these communications, network device 22 transmits a message over network 24. Mobile device 60 receives the message and encrypts the message using the pre-loaded encryption key. Mobile device 60 then transmits the encrypted message over network 24. Network device 22 receives the encrypted message and decrypts the encrypted message. Network device 22 compares the original message to the decrypted message and if the messages match, network device 22 puts itself into a state to begin negotiations with connector 26. In one embodiment, the original message transmitted by network device 22 is a randomly generated message.

Next, the network administrator or network personnel disconnect mobile device 60 from network 24 and port 22c and communicatively couple connector 26 to network 24, as indicated by dashed lines in FIG. 4. In this reset procedure, the system administrator or network personnel verify the network connection is safe and that no devices that could be used for eavesdropping are between network device 22 and end device 28.

After mobile device 60 has initialized or reset network device 22, network device 22 transmits a reset signal to connector 26. Connector 26 receives the reset signal and begins transmitting count values in a count sequence over network 24. Network device 22 receives the count values and begins communicating network traffic to end device 28. This continues until the count sequence is broken and network device 22 discontinues communications with end device 28.

In another reset procedure, the network administrator or network personnel verify that network device 22 is communicatively coupled to network 24 via port 22c and that connector 26 is communicatively coupled to network 24 and end device 28, with no devices that could be used for eavesdropping between network device 22 and end device 28. Next, network device 22 is controlled manually or via control signals on control path 36 to establish communications with connector 26.

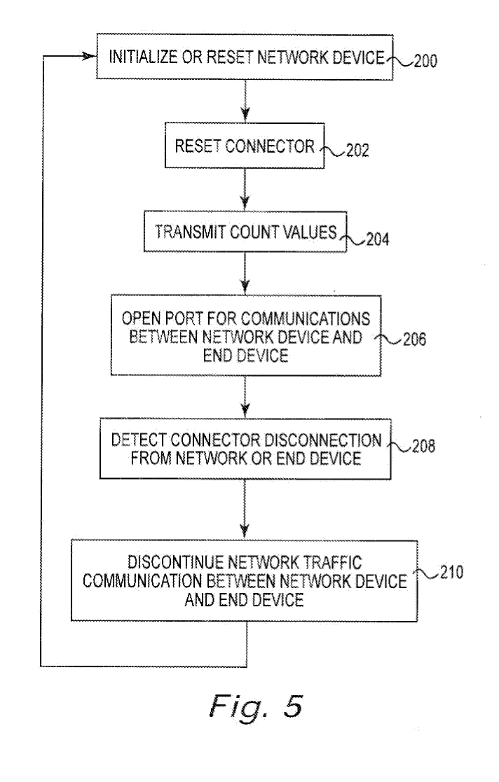

FIG. 5 is a flow chart illustrating one embodiment of network communications using system 20. At 200, network device 22 is initialized or reset. One of at least two procedures can be used to initialize or reset network device 22. In one procedure, network device 22 is controlled manually or by control signals on control path 36. In another procedure, a mobile device, such as mobile device 60 is used to initialize or reset network device 22.

At 202, after network device 22 is initialized or reset, network device 22 waits a short delay, such as 15 seconds or 30 seconds, and then transmits a reset signal that includes data for subsequent count value transmissions from connector 26 to network device 22. Connector 26 receives the reset signal from network device 22 and uses the data from the reset signal for count value transmissions. At 204, connector 26 begins transmitting count values in a count sequence over network 24 to network device 22. In one embodiment, connector 26 begins with the initial count value received in the reset signal. In one embodiment, connector 26 increments or decrements the count value between count value transmissions based on the increment or decrement indication in the reset signal. In one embodiment, connector 26 increments or decrements the count value by the increment or decrement value received in the reset signal. In one embodiment, connector 26 transmits count values at the time interval in the reset signal between transmitted count values. In one embodiment, connector 26 transmits the session identification number received in the reset signal with the count value. In one embodiment, connector 26 encrypts each count value with the encryption key received in the reset signal.

At 206, network device 22 receives the first properly formed count value signal or packet and network device 22 opens port 22c for communicating network traffic between network device 22 and end device 28. Connector 26 continues transmitting count values and network device 22 continues receiving and analyzing the count values to detect and determine whether connector 26 has been, at least temporarily, disconnected from network 24 or end device 28.

At 208, if connector 26 is, at least temporarily, disconnected from network 24 or end device 28, connector 26 discontinues the count sequence by resetting the count value to a reset value, such as zero, or by resetting the count value to a network reset value or a device reset value. Connector 26 transmits the new count value over network 24. If connector 26 is disconnected from network 24 and not reconnected to network 24, network device 22 times out waiting for another count value.

At 210, network device 22 either times out waiting for another count value or network device 22 receives the count value transmitted from connector 26 and determines that the count value does not continue the count sequence. Network device 22 discontinues network traffic communications with end device 28. To re-establish communications between network device 22 and end device 28, network device 22 is reset at 200 and the process repeats.

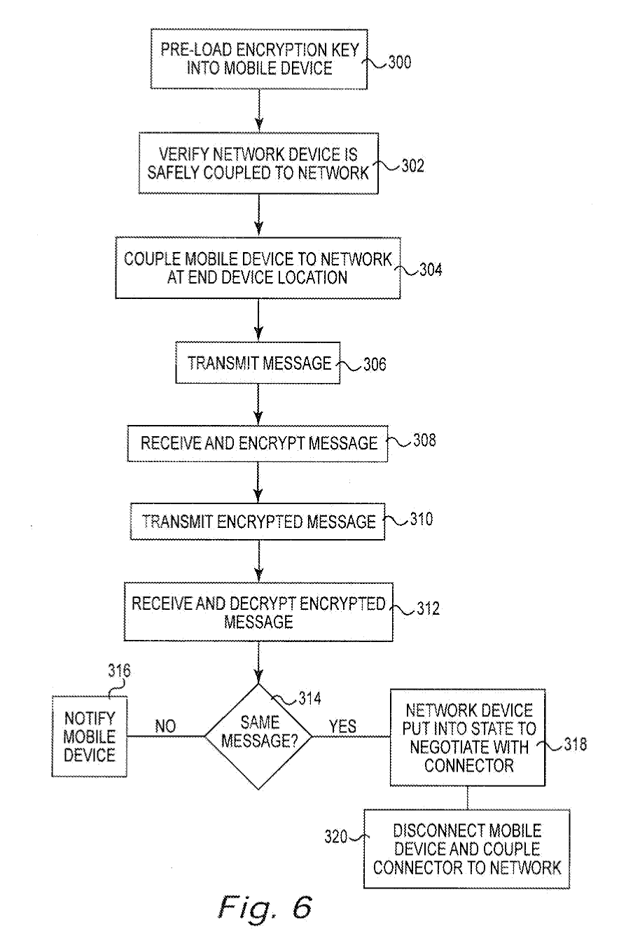

FIG. 6 is a flow chart illustrating one embodiment of initializing or resetting network device 22 using mobile device 60. At 300, mobile device 60 is pre-loaded with a private encryption key that is shared with network device 22. At 302, the network administrator or network personnel verify that network device 22 is communicatively coupled to network 24 via port 22c, with no devices that could be used for eavesdropping between network device 22 and network 24. Next, at 304, the network administrator or network personnel go to the location of the end device 28 and communicatively couple mobile device 60 to network device 22 at port 22c over network 24.

After mobile device 60 is connected to network device 22 via network 24, mobile device 60 and network device 22 communicate to initialize or reset network device 22. At 306, network device 22 transmits a message over network 24. At 308, mobile device 60 receives the message and encrypts the message using the pre-loaded encryption key. At 310, mobile device 60 transmits the encrypted message over network 24. At 312, network device 22 receives the encrypted message and decrypts the encrypted message. At 314, network device 22 compares the original message to the decrypted message. At 316, if the messages do not match, network device 22 notifies mobile device 60 and the process can be repeated by disconnecting mobile device 22 from network 24 and reconnecting mobile device 60 to network 24. At 318, if the messages match, network device 22 puts itself into a state to begin negotiations with connector 26 and, at 320, the network administrator or network personnel disconnect mobile device 60 from network 24 and port 22c and communicatively couple connector 26 to network 24.

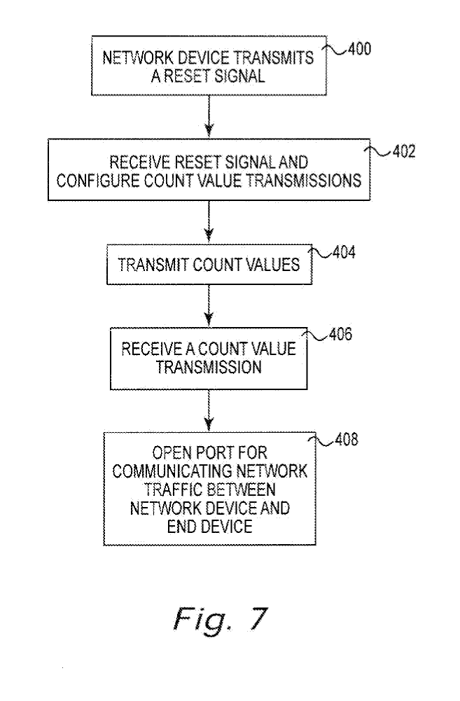

FIG. 7 is a flow chart illustrating one embodiment of resetting connector 26 and opening communications between network device 22 and end device 28. At 400, after network device 22 is initialized or reset, network device 22 waits a short delay, such as 15 seconds or 30 seconds, and then transmits a reset signal that includes data for subsequent count value transmissions from connector 26 to network device 22. At 402, connector 26 receives the reset signal from network device 22 and uses the data from the reset signal to configure count value transmissions. At 404, connector 26 begins transmitting count values in a count sequence over network 24 to network device 22. At 406, network device 22 receives a first properly formatted or formed count value transmission and, at 408, network device 22 opens port 22c for communicating network traffic between network device 22 and end device 28.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A connector comprising:
a circuit configured to be coupled to a network and an end device and to transmit count values in a count sequence over the network to detect whether the circuit has been, at least temporarily, disconnected from at least one of the network and the end device.

2. The connector of claim 1, wherein the circuit is configured to discontinue the count sequence with the count values if the circuit is, at least temporarily, disconnected from at least one of the network and the end device.

3. The connector of claim 1, wherein the circuit is configured to receive a reset signal prior to network communications being transmitted to the end device and the reset signal includes at least one of an initial count value in the count sequence, a time interval between transmitted count values, a session identification number, and an encryption key.

4. The connector of claim 1, wherein the circuit is configured to transmit the count values with a time interval between transmitted count values and to change the count values during the time interval between transmitted count values.

5. The connector of claim 1, wherein the circuit is configured to encrypt the count values and transmit encrypted count values that are used to detect whether the circuit has been, at least temporarily, disconnected from at least one of the network and the end device.

6. The connector of claim 1, wherein the circuit is powered over the network and the circuit is configured to discontinue the count sequence with the count values if the circuit is, at least temporarily, disconnected from the network and powered down.

7. A network device comprising:
a circuit configured to be coupled to the network and communicate with an end device over the network and to receive count values in a count sequence that are used to detect whether the circuit has been, at least temporarily, disconnected from the end device.

8. The network device of claim 7, wherein the circuit is configured to continue communicating with the end device if the count values continue the count sequence and to discontinue communicating with the end device if the count values discontinue the count sequence.

9. The network device of claim 7, wherein the circuit is configured to transmit a reset signal in response to one of directly controlling the circuit and communicating with the circuit over the network via a mobile device, and the reset signal includes at least one of an initial count value in the count sequence, a time interval between transmitted count values, a session identification number, and an encryption key.

10. The network device of claim 7, comprising ports, wherein the circuit is configured to provide different encryption keys for different ports or groups of ports.

11. The network device of claim 7, wherein the circuit is configured to decrypt encrypted count values to determine whether the circuit has been, at least temporarily, disconnected from the end device.

12. A method of network communications comprising:
connecting a first circuit to an end device and to a network;
connecting a second circuit to the network;
transmitting count values in a count sequence from the first circuit over the network;
receiving the count values at the second circuit over the network; and
determining from the count values whether the first circuit has been, at least temporarily, disconnected from at least one of the network and the end device.

13. The method of claim 12, comprising:
continuing the count sequence with the count values if the first circuit remains connected to the network and the end device;
discontinuing the count sequence with the count values if the first circuit is, at least temporarily, disconnected from at least one of the network and the end device;
continuing communications between the second circuit and the end device if the count values continue the count sequence; and
discontinuing communications between the second circuit and the end device if the count values discontinue the count sequence.

14. The method of claim 12, comprising:
encrypting the count values via the first circuit;
transmitting encrypted count values;
decrypting the encrypted count values via the second circuit; and
determining whether the first circuit has been, at least temporarily, disconnected from at least one of the network and the end device via decrypted count values.

15. The method of claim 12, comprising:
transmitting a reset signal from the second circuit to the first circuit in response to one of directly controlling the second circuit and communicating with the second circuit over the network via a mobile device, wherein the reset signal includes at least one of an initial count value in the count sequence, a time interval between transmitted count values, a session identification number, and an encryption key.
